(19) United States
(12) Patent Application Publication
(10) Pub. No.: US 2023/0383128 A1
(43) Pub. Date: Nov. 30, 2023

(54) ANTIFOULING COATING COMPOSITION

(71) Applicant: CHUGOKU MARINE PAINTS, LTD., Hiroshima (JP)

(72) Inventors: SHOTARO HARADA, Hiroshima (JP); Junnai IKADAI, Hiroshima (JP)

(73) Assignee: CHUGOKU MARINE PAINTS, LTD., Hiroshima (JP)

(21) Appl. No.: 18/202,890

(22) Filed: May 27, 2023

(30) Foreign Application Priority Data
May 31, 2022 (JP) 2022-089123
Jul. 28, 2022 (JP) 2022-120877

(51) Int. Cl. C09D 5/16; C09D 143/04; C09D 7/61; C09D 129/04

(52) U.S. Cl. CPC C09D 5/16; C09D 143/04; C09D 7/61; C09D 129/04

(57) ABSTRACT

An antifouling coating composition contains a silyl ester polymer, at least one rosin compound selected from rosin and rosin derivatives, a poly(vinyl alcohol) resin, and water. A method for producing an antifouling substrate, includes subjecting a substrate to application of or impregnation with the antifouling coating composition to provide an applied body or an impregnated body, and drying the applied body or the impregnated body.

### CROSS-REFERENCE TO RELATED APPLICATIONS

The present application claims the priority from Japanese Patent Application No. 2022-089123 filed on May 31, 2022, and Japanese Patent Application No. 2022-120877 filed on Jul. 28, 2022, which are incorporated herein by reference in their entirety.

### BACKGROUND OF THE INVENTION

### Field of the Invention

The present disclosure relates to an antifouling coating composition, an antifouling coating film, an antifouling substrate, and a method for producing an antifouling substrate.

### Description of the Related Art

Hitherto, resins that can be diluted with organic solvents, such as oil type resins, vinyl type resins, acrylic type resins, and chlorinated rubber type resins, have been used as resins for antifouling coating materials. In recent years, there have been advances in the development of waterborne antifouling coating materials having smaller amounts of volatile organic compounds (VOCs) from the viewpoints of environmental conservation and improvements of coating work environments (for example, see International Publication No. 2005/116155 and Japanese Unexamined Patent Application Publication No. 2003-277680).

Waterborne antifouling coating materials are effective in reducing the amounts of VOCs used. Waterborne resins used in waterborne antifouling coating materials, however, have a high affinity for water. For this reason, a coating film containing a waterborne resin cracks easily when immersed in water, such as seawater. Ultimately, the coating film collapses, making it difficult to exhibit antifouling properties over a long period of time (long-term antifouling properties).

### SUMMARY OF THE INVENTION

Antifouling coating materials containing hydrolyzable resins have been known as coating materials capable of imparting self-polishing properties to coating films and forming coating films excellent in long-term antifouling properties. A possible way to improve the crack resistance of an antifouling coating film containing a hydrolyzable resin is to add a non-hydrolyzable resin. However, when a non-hydrolyzable resin is added to such a waterborne antifouling coating material, the hydrolysis of the hydrolyzable resin may be inhibited to deteriorate the self-polishing properties of the coating film. Thus, it has been difficult to form an antifouling coating film excellent in crack resistance and long-term antifouling properties in a well-balanced manner.

The present disclosure is directed to providing a waterborne antifouling coating composition capable of forming an antifouling coating film with excellent crack resistance and long-term antifouling properties.

The disclosers have found that the problem described above can be resolved by the use of an antifouling coating composition having the following composition. That is, an antifouling coating composition according to an embodiment of the present disclosure contains a silyl ester polymer, at least one rosin compound selected from rosin and rosin derivatives, a poly(vinyl alcohol) resin, and water.

### Advantageous Effects of the Invention

According to the present disclosure, a waterborne antifouling coating composition capable of forming an antifouling coating film with excellent crack resistance and long-term antifouling properties can be provided.

### DESCRIPTION OF EMBODIMENTS

An embodiment of the present disclosure will be described in detail below.

Each component described in this specification can be used alone or in combination of two or more.

The term “polymer” is used in the sense of including homopolymers and copolymers.

(Meth)acrylate is a generic term for acrylate and methacrylate. The same applies to (meth)acrylic acid and so forth.

In the present disclosure, the numerical range “n1 to n2” refers to n1 or more and n2 or less, where n1 and n2 are freely-selected numbers satisfying n1<n2.

The term “structural unit derived from XX” indicates that, for example, when XX is expressed as A¹A²C=CA³A⁴, where C═C is a polymerizable carbon-carbon double bond, and A¹ to A⁴ are each an atom or group attached to a carbon atom, the structural unit is represented by the following formula.

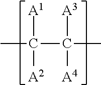

### Antifouling Coating Composition

The antifouling coating composition according to an embodiment of the present disclosure (hereinafter also referred to as a “composition of the present disclosure”) contains a silyl ester polymer, at least one rosin compound selected from rosin and rosin derivatives, a poly(vinyl alcohol) resin, and water, which are described below.

### Silyl Ester Polymer

The composition according to an embodiment of the present disclosure contains a silyl ester polymer. The silyl ester polymer is a type of hydrolyzable resin. The hydrolyzable resin dissolves as the hydrolysis of the resin proceeds in seawater to exhibit the self-polishing properties of a coating film. This results in appropriate renewal of a surface of the coating film and elution of the antifouling agent, which is used as needed, to continuously exhibit the antifouling properties.

Examples of the silyl ester polymer include polymers each including a structural unit (a-1) derived from a polymerizable monomer (a1) represented by the following formula (a1). The silyl ester polymer may include one or more types of structural units (a-1).

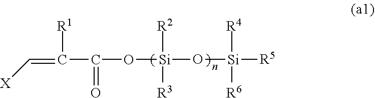

Each of the symbols in formula (a1) will be described below.

R¹ is a hydrogen atom or a methyl group, preferably a methyl group.

R² to R⁶ are each independently a monovalent organic group having 1 to 20 carbon atoms and optionally having a heteroatom. Examples of the above organic group include linear or branched alkyl groups, cycloalkyl groups, and aryl groups, each optionally having a heteroatom, such as an oxygen atom, intervening between carbon atoms. The organic group is preferably a linear or branched alkyl group having 1 to 8 carbon atoms, more preferably a branched alkyl group having 3 to 8 carbon atoms, from the viewpoint of, for example, enabling easy formation of a coating film excellent in long-term antifouling properties and crack resistance.

Examples of linear or branched alkyl groups include a methyl group, an ethyl group, a propyl group, an isopropyl group, a butyl group, an isobutyl group, a sec-butyl group, a tert-butyl group, a pentyl group, a hexyl group, and 2-ethylhexyl group. An isopropyl group is preferred.

n is an integer of 0 or 1 or more, preferably 0.

The upper limit of n may be 50, 10, or 5, for example.

X is a hydrogen atom or a group represented by R⁷—O—C(═O)—, preferably a hydrogen atom. R⁷ is a hydrogen atom, a monovalent organic group having 1 to 20 carbon atoms and optionally having a heteroatom, or a silyl group represented by R⁸R⁹R¹⁰Si—, preferably an isopentyl group. R⁸, R⁹, and R¹⁰ are each independently a monovalent organic group having 1 to 20 carbon atoms and optionally having a heteroatom. Examples of the monovalent organic group having 1 to 20 carbon atoms and optionally having a heteroatom include the specific examples described above.

The polymerizable monomer (a1) is preferably a trialkylsilyl (meth)acrylate, an alkyldiarylsilyl (meth)acrylate, or an aryldialkylsilyl (meth)acrylate, more preferably a trialkylsilyl (meth)acrylate. Examples of the trialkylsilyl (meth)acrylate include trimethylsilyl (meth)acrylate, triethylsilyl (meth)acrylate, tripropylsilyl (meth)acrylate, triisopropylsilyl (meth)acrylate, tributylsilyl (meth)acrylate, triisobutylsilyl (meth)acrylate, tri-sec-butylsilyl (meth)acrylate, tri-2-ethylhexylsilyl (meth)acrylate, and butyldiisopropylsilyl (meth)acrylate. Examples of the polymerizable monomer (a1) also include polymerizable monomers in which n is 2 or more in formula (a1), such as 1-(meth)acryloyloxynonamethyltetrasiloxane. Among these, the polymerizable monomer (a1) is preferably a trialkylsilyl (meth)acrylate having a branched alkyl group, more preferably a triisopropylsilyl (meth)acrylate, particularly preferably triisopropylsilyl methacrylate, from the viewpoint of, for example, enabling easy formation of a coating film excellent in long-term antifouling properties and crack resistance in a well-balanced manner.

The silyl ester polymer can further include a structural unit (a-2) derived from another ethylenically unsaturated monomer (hereinafter also referred to as a “polymerizable monomer (a2)”). The silyl ester polymer may include one or more types of structural units (a-2).

Examples of the polymerizable monomer (a2) include at least one monomer selected from (meth)acrylic acid and esters thereof (hereinafter also referred to as a “(meth)acrylic monomer”), styrene, α-methylstyrene, vinyl toluene, vinyl acetate, vinyl propionate, maleic acid, itaconic acid, (meth)acrylic acid amide, (meth)acrylonitrile, aliphatic carboxylic acid metal (meth)acrylate, and reactive surfactants.

Examples of the (meth)acrylic monomer include (meth)acrylic acid; alkyl (meth)acrylates each having an alkyl group having 1 to 18 carbon atoms, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth) acrylate, 2-ethylhexyl (meth) acrylate, n-octyl (meth)acrylate, decyl (meth)acrylate, lauryl (meth)acrylate, and stearyl (meth)acrylate; cycloalkyl (meth)acrylates each having a cycloalkyl group having 3 to 18 carbon atoms, such as cyclohexyl (meth)acrylate; aromatic ring-containing (meth)acrylates, such as phenyl (meth)acrylate, benzyl (meth)acrylate, and phenoxyethyl (meth)acrylate; alkoxyalkyl (meth)acrylates each having an alkoxyalkyl group having 2 to 18 carbon atoms, such as methoxymethyl (meth) acrylate, methoxyethyl (meth) acrylate, methoxybutyl (meth)acrylate, and ethoxybutyl (meth)acrylate; hydroxyalkyl (meth)acrylates, such as hydroxymethyl (meth)acrylate, 2-hydroxyethyl (meth)acrylate, 2-hydroxypropyl (meth)acrylate, and 4-hydroxybutyl (meth)acrylate; dialkylaminoalkyl (meth)acrylates, such as dimethylaminoethyl (meth)acrylate and dimethylaminopropyl (meth)acrylate; and glycidyl (meth) acrylate.

One or more (meth)acrylic monomers can be used.

A reactive surfactant (also referred to as a reactive emulsifier) refers to a surfactant having a polymerizable unsaturated bond, such as an ethylenically unsaturated bond, in its molecule. Examples of the reactive surfactant include anionic surfactants each having a sulfonate group or a sulfate ester group and a polymerizable unsaturated bond in its molecule; and nonionic surfactants each having a polyoxyalkylene skeleton and a polymerizable unsaturated bond in its molecule. Examples of commercially available reactive surfactants include the Aqualon series (available from DKS Co., Ltd.), the Adeka Reasoap series (available from Adeka Corporation), and the Latemul PD series (available from Kao Corporation). One or more reactive surfactants can be used.

The proportion of the structural unit (a-1) in the silyl ester polymer is preferably 30% or more by mass, more preferably 40% or more by mass, still more preferably 45% or more by mass, and preferably 80% or less by mass, more preferably 75% or less by mass, still more preferably 70% or less by mass, and may be a numerical range of any combination of these lower and upper limits, for example, 30% to 80% by mass.

The proportion of the structural unit (a-2) in the silyl ester polymer is preferably 20% or more by mass, more preferably 25% or more by mass, still more preferably 30% or more by mass, and preferably 70% or less by mass, more preferably 60% or less by mass, still more preferably 55% or less by mass, and may be a numerical range of any combination of these lower and upper limits, for example, 20% to 70% by mass.

When the proportion of each structural unit contained is within the above range, an antifouling coating film formed from the composition according to an embodiment of the present disclosure tends to have appropriate hydrolyzability and excellent long-term antifouling properties. The proportion of each structural unit contained is measured by nuclear magnetic resonance (NMR) spectroscopy.

One or more silyl ester polymers can be used.

The proportion of the silyl ester polymer contained is preferably 5% or more by mass, more preferably 10% or more by mass, and preferably 30% or less by mass, more preferably 25% or less by mass, still more preferably 20% or less by mass, based on 100% by mass of the solid content of the composition according to an embodiment of the present disclosure, and may be a numerical range of any combination of these lower and upper limits, for example, 5% to 30% by mass. In this case, there is a tendency that an antifouling coating film having appropriate self-polishing properties of a coating film surface can be formed. In the present disclosure, the amounts and proportions of components contained are measured by NMR or infrared spectroscopy (IR) (attenuated total reflection infrared spectroscopy, ATR). Specifically, the silyl ester polymer and the rosin compound can be measured by IR (ATR). The poly(vinyl alcohol) resin can be measured by NMR. When the measurement is difficult, the amounts and proportions of components contained can be calculated from the amounts of components charged in the preparation of the composition.

In an embodiment of the present disclosure, the solid content of the composition or the solid content of each component (for example, aqueous dispersion) refers to a nonvolatile matter content when the composition or each component is dried in a constant-temperature chamber at 108° C. for 3 hours, as described in Examples below.

Examples of a method for producing the silyl ester polymer include a solution polymerization method, a bulk polymerization method, a suspension polymerization method, and an emulsion polymerization method. A solution polymerization method with a polymerization initiator is preferred because of its high versatility.

A polymerization initiator may be used during the polymerization of a polymerizable monomer. Various radical polymerization initiators can each be used as the polymerization initiator. Radical polymerization initiators may be used alone or in combination of two or more. These radical polymerization initiators may be added to the reaction system only at the start of the polymerization reaction. They may also be added to the reaction system both at the start and in the middle of the reaction. Specific examples thereof include azo compounds, such as 2,2′-azobis(isobutyronitrile), 2,2′-azobis(2-methylbutyronitrile), 2,2′-azobis(2,4-dimethylvaleronitrile), and 4,4′-azobis(4-cyanovaleric acid); organic peroxides, such as tert-butyl peroxyoctoate, tert-butyl peroxybenzoate, and di-tert-butyl peroxide; persulfates, such as ammonium persulfate, potassium persulfate, and sodium persulfate; and hydrogen peroxide. The amount of polymerization initiator used is, for example, 0.1 to 20 parts by mass based on 100 parts by mass of the total of the polymerizable monomers used to form the silyl ester polymer.

A chain transfer agent may be used in the polymerization of the polymerizable monomer. One chain transfer agent may be used alone, or two or more chain transfer agents may be used in combination. Examples of chain transfer agents include an α-methylstyrene dimer, thiophenol, diterpene, terpinolene, γ-terpinene; mercaptans, such as thioglycolic acid, 2-ethylhexyl thioglycolate, mercaptopropionic acid, 2-ethylhexyl mercaptopropionate, tert-dodecylmercaptan, and n-dodecylmercaptan; halides, such as carbon tetrachloride, methylene chloride, bromoform, and bromotrichloroethane; and secondary alcohols, such as isopropanol and glycerol. The amount of chain transfer agent used is, for example, 0.1 to 5 parts by mass based on 100 parts by mass of the total of the polymerizable monomers used to form the silyl ester polymer.

A solvent may be used in the polymerization of the polymerizable monomer. Examples of the solvent include organic solvents and water. Examples of organic solvents include aromatic hydrocarbon solvents, such as toluene, o-xylene, m-xylene, p-xylene, ethylbenzene, and mesitylene; alcohol solvents, such as ethanol, propanol, isopropyl alcohol, butanol, and isobutanol; ether solvents, such as propylene glycol monomethyl ether and dipropylene glycol monomethyl ether; ketone solvents, such as methyl ethyl ketone, methyl isobutyl ketone, methyl amyl ketone, and cyclohexanone; and ester solvents, such as ethyl acetate, butyl acetate, and propylene glycol monomethyl ether acetate.

In the production of the composition according to an embodiment of the present disclosure, an aqueous dispersion, particularly an aqueous emulsion, of the silyl ester polymer is preferably used from the viewpoint of the physical properties of a coating film. The proportion of the solid content in the aqueous dispersion of the silyl ester polymer is preferably 30% or more by mass, more preferably 40% or more by mass, and preferably 70% or less by mass, more preferably 60% or less by mass, from the viewpoint of the stability of the dispersion, and may be a numerical range of any combination of these lower and upper limits, for example, 30% to 70% by mass.

The aqueous dispersion of the silyl ester polymer is a dispersion in which the silyl ester polymer is dispersed in a dispersion medium containing water (hereinafter also referred to as an “aqueous medium”). The aqueous medium is not limited to a particular medium as long as it contains water. The aqueous medium preferably has a water content of 50% to 100% by mass, more preferably 60% to 100% by mass.

The aqueous medium may contain a medium other than water. Examples of the medium other than water include acetone, methyl alcohol, ethyl alcohol, n-propyl alcohol, isopropyl alcohol, n-butyl alcohol, isobutyl alcohol, 2-methoxyethanol, 2-ethoxyethanol, 2-butoxyethanol, 1-methoxy-2-propanol, 1-ethoxy-2-propanol, diacetone alcohol, dioxane, ethylene glycol, ethylene glycol dimethyl ether, ethylene glycol diethyl ether, ethylene glycol monopropyl ether, and ethylene glycol monohexyl ether. One or more of these media can be used.

The aqueous emulsion of the silyl ester polymer can be prepared, for example, by emulsifying a solution containing the silyl ester polymer. Examples of the emulsification method in this case include known methods, such as a natural emulsification method, a surface chemical emulsification method, an electric emulsification method, a capillary emulsification method, a phase inversion emulsification method, a mechanical emulsification method, and an ultrasonic emulsification method. A surfactant (also referred to as an “emulsifier”) may also be used. Examples of a solvent for the solution include the organic solvents described above.

Examples of the surfactant include anionic surfactants, nonionic surfactants, cationic surfactants, amphoteric surfactants, and polymeric surfactants. These surfactants may be used alone or in combination of two or more. Examples of anionic surfactants include fatty acid salts, such as sodium lauryl sulfate, higher alcohol sulfate ester salts, alkylbenzenesulfonates, such as sodium dodecylbenzenesulfonate, polyoxyethylene alkyl ether sulfates, polyoxyethylene polycyclic phenyl ether sulfates, polyoxynonyl phenyl ether sulfonates, polyoxyethylene-polyoxypropylene glycol ether sulfates, and dioctyl sulfosuccinates. Examples of nonionic surfactants include polyoxyethylene alkyl ethers, polyoxyethylene nonylphenyl ethers, sorbitan fatty acid esters, polyoxyethylene fatty acid esters, and polyoxyethylene-polyoxypropylene block polymers. Examples of cationic surfactants include alkylamine salts and quaternary ammonium salts.

When the aqueous emulsion of the silyl ester polymer contains a surfactant, the amount of surfactant used is preferably 0.1 parts or more by mass, more preferably 1 part or more by mass, still more preferably 2 parts or more by mass, and preferably 10 parts or less by mass, more preferably 8 parts or less by mass, based on 100 parts by mass of the silyl ester polymer, and may be a numerical range of any combination of these lower and upper limits, for example, 0.1 to 10 parts by mass.

The aqueous emulsion of the silyl ester polymer can also be directly prepared by emulsion polymerization of polymerizable monomers to be formed into the silyl ester polymer. Examples of the emulsion polymerization method include, in addition to the usual emulsion polymerization method, a seed polymerization method, a mini-emulsion polymerization method, and a precipitation polymerization method. In the emulsion polymerization, the above-described reactive surfactant is preferably used as part of the polymerizable monomers.

The weight-average molecular weight (Mw) of the silyl ester polymer is preferably 3,000 or more, more preferably or more, and preferably 7,000,000 or less, more preferably 5,000,000 or less, more preferably 3,000,000 or less, and may be a numerical range of any combination of these lower and upper limits, for example, 3,000 to 7,000,000. In one embodiment, the weight-average molecular weight (Mw) of the silyl ester polymer may be 70,000 or less, 50,000 or less, or or less. Mw can be measured by a gel permeation chromatography (GPC) method and is a value in terms of polystyrene.

### Rosin Compound

The composition according to an embodiment of the present disclosure contains a rosin compound. The rosin compound is at least one selected from rosin and rosin derivatives. A rosin compound contributes, for example, to adjusting the consumption rate and improving the long-term antifouling properties of a coating film.

Examples of rosin derivatives include hydrogenated rosin, disproportionated rosin, and metal salts of rosin. Examples of metal salts include alkali metal salts, such as a sodium salt and a potassium salt, a zinc salt, a copper salt, an aluminum salt, a magnesium salt, a calcium salt, and a barium salt.

Examples of rosin compounds include rosins, such as gum rosin, wood rosin, and tall oil rosin; and rosin derivatives, such as hydrogenated rosin, disproportionated rosin, and metal salts of rosin. Examples of metal salts of rosin include, in addition to the above-described metal salts of rosin, metal salts of hydrogenated rosin and metal salts of disproportionated rosin. As the rosin compound, at least one selected from rosin resin acids and derivatives thereof, which are components contained in rosin, may be used. Examples of rosin resin acids and derivatives thereof include abietic acid, neoabietic acid, dehydroabietic acid, secodehydroabietic acid, dihydroabietic acid, tetrahydroabietic acid, pimaric acid, isopimaric acid, levopimaric acid, palustric acid, and sandaracopimaric acid.

The addition of the rosin compound is effective in developing antifouling properties. Among the rosin compounds, the metal salts of rosin are preferred, the metal salts of rosin other than alkali metal salts are more preferred, and the rosin zinc salt is even more preferred, because of their superior long-term antifouling properties.

The rosin metal salt may be synthesized by a known method, or a commercially available product may be used. When the rosin metal salt is synthesized, an organic solvent may be used. As the organic solvent, the organic solvents exemplified as the solvents that can be used in the production of the silyl ester polymer can be used.

One or more rosin compounds can be used.

The proportion of the rosin compound contained is preferably 0.8% or more by mass, more preferably 1.2% or more by mass, still more preferably 1.7% or more by mass, particularly preferably 2.2% or more by mass, and preferably 15% or less by mass, more preferably 10% or less by mass, still more preferably 5% or less by mass, even more preferably 4.5% by mass or less, particularly preferably 4.3% or less by mass, based on 100% by mass of the solid content of the composition according to an embodiment of the present disclosure, and may be a numerical range of any combination of these lower and upper limits, for example, 0.8% to 15% by mass. In this case, there is a tendency that the long-term antifouling properties of a coating film can be further improved.

In the composition according to an embodiment of the present disclosure, the mass ratio of the silyl ester polymer to the rosin compound (silyl ester polymer content/rosin compound content) is preferably 2.8 or more, more preferably 3 or more, still more preferably 3.5 or more, particularly preferably 4 or more, and preferably 15 or less, more preferably 12 or less, still more preferably 10 or less, even more preferably 8 or less, particularly preferably 6 or less, and may be a numerical range of any combination of these lower and upper limits, for example, 2.8 to 15.

In one embodiment, the mass ratio of the silyl ester polymer to the rosin compound can be determined by the following procedure or a method according to the following procedure.
(1) From the composition according to an embodiment of the present disclosure, a mixed solvent of acetone and toluene is used to extract components (soluble components) that are soluble in the mixed solvent.
(2) The soluble components extracted in (1) above is centrifuged to separate the supernatant.
(3) The supernatant obtained in (2) above is dried without heat (for example, dried under reduced pressure for one week) to obtain a solid.
(4) The solid of (3) above is pulverized, and IR (ATR) measurement is performed.
(5) In an IR spectrum obtained in (4) above, a peak characteristic of the silyl ester polymer and a peak characteristic of the rosin compound are selected, and the peak area ratio of the two peaks is calculated. In one embodiment, the peak area ratio of the peak around 1,700 cm⁻¹ (derived from stretching vibrations in the ester bond of the silyl ester polymer) to the peak around 1,600 cm⁻¹ (derived from carboxylate of the rosin compound) is calculated. When the above peaks overlap, the peak area ratio is calculated after the peaks are separated on the basis of a known method. The area ratio corresponds to the mass ratio of the silyl ester polymer to the rosin compound.

The above IR spectrum can be measured and obtained with a system of Nicolet iN5 connected to Nicolet iS10 FT-IR (both available from Thermo Fisher Scientific Inc.) under the following conditions: ATR crystal: germanium, incident angle: 45°, and resolution: 4 cm⁻¹.

The composition containing the silyl ester polymer and the rosin compound in the above mass ratio can form an antifouling coating film with even better crack resistance and long-term antifouling properties (static antifouling properties and dynamic antifouling properties). In the evaluation of antifouling properties, in the case of a static antifouling property test, the coating film does not easily peel off even if the coating film cracks, and the antifouling properties do not deteriorate in some cases. On the other hand, in the case of a dynamic antifouling property test, the coating film peels off easily when cracked, and the antifouling properties are likely to deteriorate significantly. The dynamic antifouling property test is a test method in which, for example, a test plate which is coated with an antifouling coating film is installed on a side surface of a rotating rotor, the rotor is immersed in seawater, and the surface of the antifouling coating film is rotated at a speed of about 12 knots.

In the production of the composition according to an embodiment of the present disclosure, the aqueous dispersion, particularly an aqueous emulsion, of the rosin compound is preferably used. The proportion of the solid content in the aqueous dispersion of the rosin compound is preferably 20% or more by mass, more preferably 35% or more by mass, and preferably 80% or less by mass, more preferably 65% or less by mass, from the viewpoint of workability in the production of a coating material, and may be a numerical range of any combination of these lower and upper limits, for example, 20% to 80% by mass.

The aqueous dispersion of the rosin compound is a dispersion in which the rosin compound is dispersed in an aqueous medium. The aqueous medium is not limited to a particular medium as long as it contains water. The proportion of water in the aqueous medium is preferably 50% to 100% by mass, more preferably 60% to 100% by mass. Specific examples of an aqueous medium other than water are as described above.

The aqueous emulsion of the rosin compound can be prepared, for example, by emulsifying a solution containing the rosin compound. Examples of the emulsification method in this case include known methods, such as a natural emulsification method, a surface chemical emulsification method, an electric emulsification method, a capillary emulsification method, a phase inversion emulsification method, a mechanical emulsification method, and an ultrasonic emulsification method. A surfactant may also be used. Examples of a solvent for the solution include the organic solvents described above. Specific examples of the surfactant include those described above.

### Poly(Vinyl Alcohol) Resin

The composition according to an embodiment of the present disclosure contains a poly(vinyl alcohol) resin. The use of the rosin compound and the poly(vinyl alcohol) resin together with the silyl ester polymer can improve the crack resistance and the long-term antifouling properties of the coating film formed from the composition in a well-balanced manner. In particular, with regard to the long-term antifouling properties, it is possible to improve the dynamic antifouling properties as well as the static antifouling properties. The reasons why the effects are provided are presumably that (1) the rosin compound contributes to adjusting the consumption rate and improving the long-term antifouling properties of the coating film, (2) the poly(vinyl alcohol) resin is a resin capable of forming a coating film by itself and forms a crystal structure due to hydrogen bonding to exhibit water resistance, thereby contributing to an improvement in crack resistance, and (3) the poly(vinyl alcohol) resin also has appropriate hydrophilicity and thus does not inhibit the hydrolysis of the silyl ester polymer and does not inhibit the self-polishing properties of the coating film. However, the reasons why the effects according to an embodiment of the present disclosure are exhibited are not limited to these presumed reasons.

The poly(vinyl alcohol) resin may be poly(vinyl alcohol), acid-modified poly(vinyl alcohol), or a mixture of both. Among these, poly(vinyl alcohol) is preferred.

Poly(vinyl alcohol) is prepared, for example, by polymerizing at least a vinyl ester compound and saponifying the resulting polymer. Examples of a method for polymerizing the vinyl ester compound include a solution polymerization method, a bulk polymerization method, a suspension polymerization method, and an emulsion polymerization method. A known method can be used to the saponification of the polymer.

Examples of the vinyl ester compound include aliphatic vinyl esters, such as vinyl formate, vinyl acetate, vinyl trifluoroacetate, vinyl propionate, vinyl valerate, vinyl butyrate, vinyl isobutyrate, vinyl pivalate, vinyl caprate, vinyl laurate, vinyl stearate, and vinyl versatate; and aromatic vinyl esters, such as vinyl benzoate. Of these, vinyl acetate is preferred. As poly(vinyl alcohol), it is preferable to use a polymer obtained by polymerizing at least vinyl acetate and saponifying the resulting poly(vinyl acetate).

Examples of the acid-modified poly(vinyl alcohol) include carboxylic acid-modified poly(vinyl alcohol), sulfonic acid-modified poly(vinyl alcohol), and phosphoric acid-modified poly(vinyl alcohol). Among these, carboxylic acid-modified poly(vinyl alcohol) is preferred.

Examples of the carboxylic acid-modified poly(vinyl alcohol) include a polymer prepared by the graft polymerization or block polymerization of poly(vinyl alcohol) and a vinyl carboxylic acid compound; a polymer prepared by the copolymerization of a vinyl ester compound and a vinyl carboxylic acid compound and then the saponification of the resulting copolymer; and a polymer prepared by the reaction of poly(vinyl alcohol) with a carboxylating agent.

Examples of the vinyl carboxylic acid compound include carboxy group-containing compounds, such as (meth)acrylic acid, maleic acid, and itaconic acid, and acid anhydrides thereof. Examples of the carboxylating agent include succinic anhydride, acetic anhydride, trimellitic anhydride, phthalic anhydride, pyromellitic anhydride, glutaric anhydride, hydrogenated phthalic anhydride, and naphthalenedicarboxylic anhydride.

The degree of saponification of the poly(vinyl alcohol) resin is preferably 85% or more by mole, more preferably 87% or more by mole, still more preferably 90% or more by mole, even more preferably 93% or more by mole, particularly preferably 95% or more by mole. The upper limit of the degree of saponification is not limited to a particular value. The upper limit may be, for example, 99.99% by mole or 99.95% by mole. The degree of saponification is measured according to “3.5 Degree of Saponification” described in JIS K 6726-1994. When the degree of saponification is equal to or more than the lower limit, the poly(vinyl alcohol) resin has a good balance between the water resistance and the hydrophilicity, and the crack resistance and the long-term antifouling properties of the coating film tend to be further improved.

The viscosity of a 4% by mass aqueous solution of the poly(vinyl alcohol) resin at 20° C. is preferably 1 mPa·s or more, more preferably 2 mPa·s or more, still more preferably 4 mPa·s or more, from the viewpoints of the crack resistance and the long-term antifouling properties, and preferably 100 mPa·s or less, more preferably 75 mPa·s or less, still more preferably 50 mPa·s or less, particularly preferably 20 mPa·s or less, from the viewpoints of the long-term antifouling properties and the crack resistance. The viscosity may be a numerical range of any combination of these lower and upper limits, for example, 1 to 100 mPa·s. The viscosity of the poly(vinyl alcohol) resin is measured with a Brookfield-type rotational viscometer according to “3.11.1 Rotational Viscometer Method” described in JIS K 6726-1994.

The average degree of polymerization of the poly(vinyl alcohol) resin is preferably 300 or more, more preferably 500 or more, and preferably 4,000 or less, more preferably 3,500 or less, still more preferably 3,000 or less, and may be a numerical range of any combination of these lower and upper limits, for example, 300 to 4,000. The average degree of polymerization of the poly(vinyl alcohol) resin is measured according to “3.7 Average Degree of Polymerization” described in JIS K 6726-1994.

One or more poly(vinyl alcohol) resins can be used.

The proportion of the poly(vinyl alcohol) resin contained is preferably 0.25% or more by mass, more preferably 0.4% or more by mass, still more preferably 0.5% or more by mass, and preferably 1.5% or less by mass, more preferably 1.4% or less by mass, still more preferably 1.3% or less by mass, based on 100% by mass of the solid content of the composition according to an embodiment of the present disclosure, and may be a numerical range of any combination of these lower and upper limits, for example, 0.25% to 1.5% by mass. When the proportion is equal to or more than the lower limit, the crack resistance tends to be further improved. When the proportion is equal to or less than the upper limit, the long-term antifouling properties tend to be further improved.

### Antifouling Agent

The composition according to an embodiment of the present disclosure preferably contains an antifouling agent.

Examples of the antifouling agent include inorganic antifouling agents and organic antifouling agents.

Examples of inorganic antifouling agents include copper and copper compounds (however, excluding pyrithione compounds), such as cuprous oxide, a copper metal powder, and copper(I) thiocyanate (copper rhodanide). Cuprous oxide and copper(I) thiocyanate (copper rhodanide) are preferred. Cuprous oxide is more preferred. The median diameter (D50) of cuprous oxide is preferably 1 to 30 μm. Cuprous oxide may be surface-treated. The surface treatment agent of cuprous oxide, such as glycerol, stearic acid, lauric acid, sucrose, lecithin, or mineral oil, is preferred from the view points of the antifouling properties of the coating film and long-term stability of the composition during storage.

The median diameter (D50) can be measured by a laser diffraction/scattering method with SALD-2200 (available from Shimadzu Corporation) as a measuring device. The details of the measurement method are described below. A 0.2% by mass aqueous solution of sodium hexametaphosphate (HMPNa) and a few drops of a neutral detergent (available from Kao Corporation, product name: Cucute) are added to a sample disperser. The solution is circulated under the application of ultrasonic waves. About 100 mg of cuprous oxide is placed in a mortar. A few drops of the above neutral detergent are added thereto. To loosen secondary aggregation of the cuprous oxide, the cuprous oxide is lightly dispersed. Water is added to the sample dispersed in the mortar so as not to foam. The sample is poured into the sample disperser. Circulation/dispersion treatment is performed for 10 minutes in the sample disperser. The particle size distribution on a volume basis is then measured with the above measuring device. When the particle size distribution is calculated, “2.70-0.20i” is used as the refractive index. The median diameter (D50) is determined from the particle size distribution.

Examples of organic antifouling agents include metal pyrithiones (pyrithione compounds), such as copper pyrithione and zinc pyrithione; tetraalkylthiuram disulfides, such as tetramethylthiuram disulfide; carbamate compounds, such as zinc dimethyldithiocarbamate, zinc ethylenebisdithiocarbamate, and bisdimethyldithiocarbamoyl zinc ethylenebisdithiocarbamate; maleimide compounds, such as 2,4,6-triphenylmaleimide, 2,3-dichloro-N-(2′,6′-diethylphenyl) maleimide, and 2,3-dichloro-N-(2′-ethyl-6′-methylphenyl) maleimide; 2,4,5,6-tetrachloroisophthalonitrile, N,N-dimethyldichlorophenylurea, 4,5-dichloro-2-n-octyl-4-isothiazolin-3-one (DCOIT), 2-methylthio-4-tert-butylamino-6-cyclopropyl-S-triazine, chloromethyl-n-octyl disulfide, N′,N′-dimethyl-N-phenyl-(N-fluorodichloromethylthio) sulfamide, and N′,N′-dimethyl-N-tolyl-(N-fluorodichloromethylthio) sulfamide; amine-organoborane complexes, such as pyridinetriphenylborane and 4-isopropylpyridinediphenylmethylborane; and (+/−)-4-[1-(2,3-dimethylphenyl)ethyl]-1H-imidazole (medetomidine).

Among these organic antifouling agents, copper pyrithione, zinc pyrithione, zinc ethylenebis(dithiocarbamate), 2-methylthio-4-tert-butylamino-6-cyclopropyl-S-triazine, 4,5-dichloro-2-n-octyl-4-isothiazolin-3-one (DCOIT), and (+/−)-4-[1-(2,3-dimethylphenyflethyl]-1H-imidazole (medetomidine) are preferred. Copper pyrithione, 4,5-dichloro-2-n-octyl-4-isothiazolin-3-one (DCOIT), and (+/−)-4-[1-(2,3-dimethylphenyl)ethyl]-1H-imidazole (medetomidine) are more preferred.

One or more antifouling agents can be used.

The proportion of the antifouling agent contained is preferably 0.01% or more by mass, more preferably 0.1% or more by mass, still more preferably 1% or more by mass, based on 100% by mass of the solid content of the composition according to an embodiment of the present disclosure. The proportion may be 5% or more by mass, 10% or more by mass, 15% or more by mass, 20% or more by mass, 25% or more by mass, or 30% or more by mass. The proportion is preferably 80% or less by mass, more preferably 75% or less by mass, still more preferably 70% or less by mass. The proportion may be a numerical range of any combination of these lower and upper limits, for example, 0.01% to 80% by mass.

### Other Components

The composition according to an embodiment of the present disclosure may contain a pigment and/or an additive as needed.

Examples of the pigment include extender pigments and coloring pigments. Examples of the additive include pigment dispersants, defoamers, thickeners, anti-settling agents, and film forming aids. One or more of these pigments can be used. One or more of these additives can be used.

Examples of extender pigments include zinc oxide, talc, silica, mica, clay, potassium feldspar, calcium carbonate, kaolin, alumina white, white carbon, aluminum hydroxide, magnesium carbonate, barium carbonate, barium sulfate, and zinc sulfide. The proportion of the extender pigment is preferably 0.1% or more by mass, more preferably 1% or more by mass, still more preferably 5% or more by mass, and preferably 90% or less by mass, more preferably 70% or less by mass, still more preferably 50% or less by mass, based on 100% by mass of the solid content of the composition according to an embodiment of the present disclosure, and may be a numerical range of any combination of these lower and upper limits, for example, 0.1% to 90% by mass.

Examples of coloring pigments include inorganic pigments and organic pigments. Examples of inorganic pigments include carbon black, red iron oxide, titanium white (titanium oxide), and yellow iron oxide. Examples of organic pigments include naphthol red and phthalocyanine blue. The proportion of the coloring pigment is preferably 0.01% or more by mass, more preferably 0.1% or more by mass, still more preferably 0.5% or more by mass, and preferably 50% or less by mass, more preferably 30% or less by mass, still more preferably 10% or less by mass, based on 100% by mass of the solid content of the composition according to an embodiment of the present disclosure, and may be a numerical range of any combination of these lower and upper limits, for example, 0.01% to 50% by mass.

The pigment dispersant is preferably a dispersant capable of uniformly wetting and dispersing the pigment in the coating composition and preparing a stable dispersion. An example of the pigment dispersant is a polymeric dispersant. The proportion of the pigment dispersant is preferably 0.01% or more by mass, more preferably 0.1% or more by mass, still more preferably 0.5% or more by mass, and preferably 5% or less by mass, based on 100% by mass of the solid content of the composition according to an embodiment of the present disclosure, and may be a numerical range of any combination of these lower and upper limits, for example, 0.01% to 5% by mass.

The defoamer is preferably a material capable of inhibiting the formation of foam during the production of the coating composition and during application, or a material capable of breaking foam formed in the coating composition. The use of defoamer can, for example, inhibit the formation of bubble traces or pinholes in the coating film, thus further improving the film-forming properties, antifouling properties, and crack resistance of the coating film. Examples of the defoamer include silicone defoamers, polymeric (non-silicone) defoamers, and mineral oil defoamers. The proportion of the defoamer is preferably 0.01% or more by mass, more preferably or more by mass, and preferably 2% or less by mass, more preferably 1.5% or less by mass, based on 100% by mass of the solid content of the composition according to an embodiment of the present disclosure, and may be a numerical range of any combination of these lower and upper limits, for example, 0.01% to 2% by mass.

As the thickener, for example, a commercially available product commonly sold as a thickener can be used. Examples of the commercially available product include, but are not particularly limited to, alkali thickeners, nonionic associative thickeners, acrylic thickeners, urethane thickeners, water-soluble polymeric thickeners, polyamide thickeners, and hydroxyethyl cellulose. The proportion of the thickener contained is preferably 0.01% or more by mass, more preferably or more by mass, and preferably 10% or less by mass, more preferably 5% or less by mass, still more preferably 1% or less by mass, based on 100% by mass of the solid content of the composition according to an embodiment of the present disclosure, and may be a numerical range of any combination of these lower and upper limits, for example, 0.01% to 10% by mass.

The anti-settling agent is preferably a material capable of inhibiting sedimentation of the pigment in the coating composition and improving the storage stability of the coating composition. Examples of the anti-settling agent include organic thixotropic agents, such as hydrogenated castor oil-based thixotropic agents, amide wax-based thixotropic agents, and polyethylene oxide-based thixotropic agents; and inorganic thixotropic agents, such as clay minerals, e.g., bentonite, smectite, and hectorite, and synthetic fine silica. The proportion of the anti-settling agent contained is preferably 0.01% to 5% by mass based on 100% by mass of the solid content of the composition according to an embodiment of the present disclosure.

Examples of the film forming aid include alcohols, glycol ethers, and esters. Specific examples thereof include alcohols each having 1 to 3 carbon atoms, such as isopropyl alcohol, and alcohols, such as 2,2,4-trimethylpentanediol and benzyl alcohol; glycol ethers, such as ethylene glycol monobutyl ether, ethylene glycol diethyl ether, diethylene glycol monobutyl ether, diethylene glycol diethyl ether, propylene glycol diethyl ether, dipropylene glycol diethyl ether, dipropylene glycol n-butyl ether, ethylene glycol monobenzyl ether, and ethylene glycol monophenyl ether; and esters, such as 2,2,4-trimethyl-1,3-pentanediol monoisobutyrate. The proportion of the film forming aid contained is preferably 0.1% or more by mass, more preferably 0.5% or more by mass, and preferably 15% or less by mass, more preferably 5% or less by mass, based on 100% by mass of the total amount of composition according to an embodiment of the present disclosure, and may be a numerical range of any combination of these lower and upper limits, for example, 0.1% to 15% by mass.

### Water

The composition according to an embodiment of the present disclosure is a waterborne antifouling coating composition. In an embodiment of the present disclosure, the “waterborne” composition refers to a composition containing water. The proportion of water in the composition according to an embodiment of the present disclosure is preferably 10% or more by mass, more preferably 15% or more by mass, and preferably 50% or less by mass, more preferably 45% or less by mass, and may be a numerical range of any combination of these lower and upper limits, for example, 10% to 50% by mass.

The proportion of the solid content in the composition according to an embodiment of the present disclosure is preferably 50% or more by mass, more preferably 55% or more by mass, and preferably 90% or less by mass, more preferably 85% or less by mass, from the viewpoint of achieving the composition excellent in application workability, and may be a numerical range of any combination of these lower and upper limits, for example, 50% to 90% by mass.

### Method for Producing Antifouling Coating Composition

The composition according to an embodiment of the present disclosure can be produced by appropriately using a known method. The composition can be produced, for example, by adding the silyl ester polymer, the rosin compound, the poly(vinyl alcohol) resin, and, if necessary, the antifouling agent and/or other components to a stirring container all at once or in any order, mixing the components with a known stirring or mixing means, and dispersing or dissolving the components in water.

In the production of the composition according to an embodiment of the present disclosure, the aqueous dispersion of the silyl ester polymer and the aqueous dispersion of the rosin compound are preferably used from the viewpoint of workability in the production of a coating.

Examples of the stirring or mixing means include a means with a paint shaker, a high-speed disperser, a sand grinding mill, a basket mill, a ball mill, a three-roll mill, a ross mixer, or a planetary mixer.

The composition according to an embodiment of the present disclosure can form a coating film on a surface of a substrate, such as a member constituting a ship, the coating film having excellent crack resistance and being able to inhibiting the adhesion of aquatic organisms over the long term. An improvement in crack resistance inhibits an increase in the surface roughness of the coating film and an increase in water stream resistance due to the formation of cracks, and contributes to a reduction in the fuel consumption of ships, for example. The composition according to an embodiment of the present disclosure is also suitable for repair coating because cracking and peeling of the coating film are less likely to occur even after applying multiple coats of the composition. The composition according to an embodiment of the present disclosure is a waterborne coating material; thus, it has very little adverse effect on the environment and the human body, and is also excellent in storage stability.

The composition according to an embodiment of the present disclosure is preferably a low VOC-type coating composition.

The term “low VOC” indicates that the amounts of volatile organic compound (VOC) components, such as organic solvents, contained in the composition are relatively small, and specifically indicates that the composition has a VOC content of 200 g/L or less when adjusted to have a viscosity suitable for coating. The VOC content of the composition according to an embodiment of the present disclosure is preferably 180 g/L or less, more preferably 160 g/L or less.

The VOC content of the composition can be calculated from the following equation (1) using the specific gravity and the solid content concentration, which are described below, of the composition.

VOC content (g/L)=specific gravity of composition×1,000×(100−solid content concentration−moisture concentration)/100 (1)

Specific gravity of composition (g/mL): A value calculated by filling a specific gravity cup having an internal volume of 100 mL with the composition at 23° C. and then measuring the mass of the composition.

Solid content concentration (% by mass): A value calculated by a method described in Examples below.

Moisture concentration (% by mass): The amount (% by mass) of water contained in 100% by mass of the composition, measured with a moisture meter (for example, CA-310, available from Nittoseiko Analytech Co., Ltd).

### Application of Antifouling Coating Composition

An antifouling coating film according to an embodiment of the present disclosure is formed from the composition according to an embodiment of the present disclosure. An antifouling substrate according to an embodiment of the present disclosure includes a substrate and the antifouling coating film according to an embodiment of the present disclosure, the antifouling coating film being disposed on a surface of the substrate.

A method for producing an antifouling substrate according to an embodiment of the present disclosure includes subjecting a substrate (target object or object to be coated) to application of or impregnation with the composition according to an embodiment of the present disclosure to provide an applied body or an impregnated body, and drying the applied body or the impregnated body.

The composition can be applied by, for example, a known method, such as air spraying, airless spraying, brush coating, or roller coating.

The composition according to an embodiment of the present disclosure with which the substrate has been subjected to application or impregnation by the above-described method is dried by leaving it for preferably about 1 to 10 days, more preferably about 1 to 7 days at, for example, −5° C. to 40° C. Thereby, an antifouling coating film can be formed. The drying of the composition may be performed under heat with air blowing.

Alternatively, the antifouling substrate according to an embodiment of the present disclosure can be produced by forming an antifouling coating film from the composition according to an embodiment of the present disclosure on the surface of a temporary substrate, peeling this antifouling coating film from the temporary substrate, and affixing the film to a target substrate to which the antifouling properties are to be imparted. In this case, the antifouling coating film may be affixed to the substrate with an adhesive layer interposed therebetween.

A surface of the substrate may be subjected to primer treatment. A layer formed from a resin-based coating material may be disposed on a surface of the substrate. Examples of the resin-based coating material include epoxy resin-based coating materials, vinyl resin-based coating materials, acrylic resin-based coating materials, and urethane resin-based coating materials. The surface of the substrate on which the antifouling coating film is disposed in this case refers to the surface that has been subjected to the primer treatment or the surface of the layer formed from the resin-based coating material.

The substrate is not particularly limited. The composition according to an embodiment of the present disclosure is preferably used for long-term antifouling of substrates in a wide range of industrial fields, such as ships, fisheries, and underwater structures. Examples of such a substrate include members constituting ships, e.g., hull outer plates such as steel plates, underwater structures, fishery materials, water supply and drainage pipes for seawater or the like in factories, thermal power plants and nuclear power plants, diver suits, underwater goggles, oxygen tanks, swimsuits, and torpedoes. Examples of ships include large steel ships such as container ships and tankers, fishing ships, FRP ships, wooden ships, and yachts. These ships may be newly built ships or repaired ships. Examples of the underwater structure include oil pipelines, water-conducting pipes, circulating water pipes, water supply and discharge ports of factories, thermal power plants, and nuclear power plants, submarine cables, seawater utilization equipment, such as seawater pumps, and various underwater civil engineering structures in megafloats, bay roads, submarine tunnels, harbor facilities, canals, waterways, and the like. Examples of fishery materials include ropes, fishing nets, fishing gear, floats, and buoys. Among these, members constituting ships, underwater structures, fishery materials, and water supply and discharge pipes are preferred. Members constituting ships and underwater structures are more preferred. Members constituting ships are particularly preferred.

In the production of the antifouling substrate according to an embodiment of the present disclosure, when the substrate is a fishing net or a steel plate, the composition according to an embodiment of the present disclosure may be directly applied to the surface of the substrate. When the substrate is a fishing net, the surface thereof may be impregnated with the composition according to an embodiment of the present disclosure. When the substrate is a steel plate, an undercoating material, such as a rust inhibitor or a primer, may be applied to the surface of the substrate in advance to form an undercoat layer, and then the composition according to an embodiment of the present disclosure may be applied to the surface of the undercoat layer. For the purpose of repair, the antifouling coating film according to an embodiment of the present disclosure may be further formed on the surface of a substrate on which the antifouling coating film according to an embodiment of the present disclosure or a known antifouling coating film is formed, such as a steel plate having a deteriorated antifouling coating film.

The thickness of the antifouling coating film according to an embodiment of the present disclosure is, for example, about 30 to 1,000 μm. An example of a method for forming an antifouling coating film is a method in which application is performed one or more times in such a manner that the thickness of the resulting antifouling coating film formed in one application is preferably 10 to 300 μm, more preferably 30 to 200 μm.

A ship having the antifouling coating film according to an embodiment of the present disclosure can inhibit the adhesion of aquatic organisms to inhibit a decrease in ship speed and an increase in fuel consumption. An underwater structure having the antifouling coating film according to an embodiment of the present disclosure can inhibit the adhesion of aquatic organisms for a long period of time to maintain the function of the underwater structure for a long period of time. A fishing net having the antifouling coating film according to an embodiment of the present disclosure is less likely to cause environmental pollution and can inhibit the adhesion of aquatic organisms, thereby inhibiting the clogging of the meshes. A water supply and drainage pipe having the antifouling coating film according to an embodiment of the present disclosure on the inner surface thereof can inhibit the adhesion and propagation of aquatic organisms, thereby inhibiting the clogging of the water supply and drainage pipe and a decrease in flow rate.

Embodiments of the present disclosure relate, for example, to the following [1] to [11].

[1] An antifouling coating composition contains a silyl ester polymer, at least one rosin compound selected from rosin and rosin derivatives, a poly(vinyl alcohol) resin, and water.

[2] In the antifouling coating composition described in [1], the silyl ester polymer may include a structural unit derived from triisopropylsilyl methacrylate.

[3] In the antifouling coating composition described in [1] or [2], the rosin compound may be a rosin metal salt.

[4] In the antifouling coating composition described in [3], the rosin metal salt may be a rosin zinc salt.

[5] In the antifouling coating composition described in any one of [1] to [4], the mass ratio of the silyl ester polymer to the rosin compound, which is a silyl ester polymer content/a rosin compound content, may be from 2.8 to 15.

[6] In the antifouling coating composition described in any one of [1] to [5], the poly(vinyl alcohol) resin may have a degree of saponification of 85% or more by mole.

[7] In the antifouling coating composition described in any one of [1] to [6], the proportion of the poly(vinyl alcohol) resin contained may be from 0.25% to 1.5% by mass based on 100% by mass of the solid content of the antifouling coating composition.

[8] The antifouling coating composition described in any one of [1] to [7] may further contain an antifouling agent.

[9] An antifouling coating film is formed from the antifouling coating composition described in any one of [1] to [8].

[10] An antifouling substrate includes a substrate and the antifouling coating film described in [9], the antifouling coating film being disposed on a surface of the substrate.

[11] A method for producing an antifouling substrate includes subjecting a substrate to application of or impregnation with the antifouling coating composition described in any one of [1] to [8] to provide an applied body or an impregnated body, and drying the applied body or the impregnated body.

### EXAMPLES

While the antifouling coating composition according to an embodiment of the present disclosure will be described in more detail below based on examples and comparative examples, the antifouling coating composition according to an embodiment of the present disclosure is not limited to the following examples. In the following examples and comparative examples, the term “part(s)” refers to “part(s) by mass”.

### Solid Content Concentration

The solid content of the composition or the solid content of each component refers to the nonvolatile matter when the composition or each component is dried in a constant-temperature chamber at 108° C. for 3 hours. Specifically, the nonvolatile matter is a residue obtained by weighing 1.0 g of a sample in a flat-bottomed dish, spreading the sample uniformly with a wire of known mass, and drying the sample in the constant-temperature chamber at 1 atm and 108° C. for 3 hours. The proportion of the solid content (solid content concentration) (% by mass) of the composition or each component was calculated from the amount of nonvolatile matter.

### Polymer Solution 1

Each reaction was performed at atmospheric pressure under a nitrogen atmosphere. Into a reaction vessel equipped with a stirrer, a reflux condenser, a thermometer, a nitrogen inlet tube, and a dropping funnel, 428.6 parts of xylene and 50 parts of triisopropylsilyl methacrylate (TIPSMA) were charged. The mixture was heated until the liquid temperature in the reaction vessel reached 85° C. while stirred with the stirrer. While the liquid temperature in the reaction vessel was maintained at 85±5° C., a mixture of 450 parts of TIPSMA, 200 parts of 2-methoxyethyl methacrylate (MEMA), 240 parts of methyl methacrylate (MMA), 60 parts of butyl acrylate (BA), and 20 parts of 2,2′-azobis(isobutyronitrile) (AIBN) was added dropwise from the dropping funnel to the reaction vessel over 3 hours.

After the completion of the dropwise addition, the reaction liquid in the reaction vessel was stirred at 85° C. for 1 hour and then at 85° C. to 95° C. for another 1 hour. Thereafter, 1 part of AIBN was added to the reaction liquid 4 times every 30 minutes while maintaining 95° C., and the liquid temperature was raised to 105° C. to complete the polymerization reaction, thereby preparing polymer solution 1. The polymer contained in the polymer solution 1 had a weight-average molecular weight (Mw) of 18,317 in terms of polystyrene, the molecular weight being measured by a GPC method described below.

### Polymer Solutions 2 and 3

Polymer solutions 2 and 3 were each prepared by performing a reaction in the same manner as in the polymer solution 1, except that the composition of the monomer mixture was changed as given in Table 1 and the reaction temperature, the dropping time, the polymerization initiator, and the like were appropriately adjusted.

TABLE 1

| | | | Polymer | Polymer | Polymer |
|---|---|---|---|---|---|
| Polymer solution | | | solution 1 | solution 2 | solution 3 |
| Monomer | Triisopropylsilyl methacrylate (TIPSMA) | parts by mass | 500 | 600 | 450 |
| mixture | 2-Methoxyethyl methacrylate (MEMA) | | 200 | | 250 |
| | 2-Methoxyethyl acrylate (MEA) | | | 250 | |
| | Methyl methacrylate (MMA) | | 240 | 150 | 250 |
| | Butyl acrylate (BA) | | 60 | | 50 |
| Evaluation of | Proportion of solid content (nonvolatile matter) | % by mass | 70.1 | 69.9 | 70.3 |
| physical | in polymer solution | | | | |
| properties | Mw of polymer | — | 18,317 | 20,839 | 22,681 |

### Production of Rosin Zinc Salt Solution

Into a reaction vessel equipped with a stirrer, a reflux condenser, and a thermometer, 561 parts of WW rosin, 167 parts of xylene, and 81 parts of zinc oxide were charged. The mixture was stirred at 70° C. to 80° C. for 8 hours. The solution was then refluxed at 70° C. to 80° C. for 3 hours under reduced pressure to remove water. The resulting solution was diluted by the addition of xylene so as to have a solid content concentration of 75% by mass, thereby preparing a rosin zinc salt solution.

### Production Example 1

Into a polyethylene vessel, 2,400 parts of the polymer solution 1, 185 parts of Noigen XL-400D (available from DKS Co., Ltd., solid content concentration: 65% by mass), and 1,300 parts of deionized water were charged. The mixture was subjected to dispersion treatment at 5,000 rpm for 20 minutes. The resulting mixture was subjected to dispersion treatment 5 passes with a high-pressure homogenizer (Star Burst HJP-25005, available from Sugino Machine Limited) at a pressure of 150 MPa. The resulting dispersion was diluted by the addition of deionized water so as to have a solid content concentration of 45% by mass, thereby preparing polymer solution emulsion 1.

### Production Examples 2 to 4

Polymer solution emulsions 2 and 3 and emulsion 1 of a rosin zinc salt were prepared in the same manner as in Production example 1, except that the polymer solution 2, the polymer solution 3, or the rosin zinc salt solution was used in place of the polymer solution 1 in Production example 1. In these productions, the pressure, the number of passes, and the type and amount of emulsifier added were appropriately adjusted.

### Production Example 5

Reaction operations were performed under a stream of nitrogen.

Into a flask fitted with a stirrer and a nitrogen inlet tube, 144.2 parts of deionized water, 210 parts of triisopropylsilyl methacrylate, 84 parts of 2-methoxyethyl methacrylate, 100.8 parts of methyl methacrylate, 25.2 parts of butyl acrylate, 8.4 parts of Aqualon AR-10 (available from DKS Co., Ltd.), and 4.2 parts of Aqualon AN-10 (available from DKS Co., Ltd.) were charged. The mixture was stirred well to prepare a pre-emulsion.

Into a flask fitted with two dropping funnels, a stirrer, a nitrogen inlet tube, a thermometer, and a reflux condenser, 55 parts of the pre-emulsion and 145 parts of deionized water were charged. The flask was heated to an internal temperature of 78° C. Then 20 parts of a 4% aqueous solution of ammonium persulfate was added thereto. The internal temperature was maintained at 78±2° C. for 40 minutes. While the same temperature was maintained, 494.3 parts of pre-emulsion was added dropwise from the dropping funnel over 2.5 hours, and then 150 parts of a 0.8% aqueous solution of ammonium persulfate was added dropwise over 3 hours. The same temperature was maintained for 2 hours after the completion of the dropping. After the mixture was cooled to room temperature, 1.4 parts of 28% aqueous ammonia and 54.3 parts of deionized water were added thereto. The mixture was filtered through a 120-mesh screen to prepare emulsion polymerization emulsion 4. The solid content concentration of the resulting emulsion polymerization emulsion 4 was 45% by mass.

### Measurement of Weight-Average Molecular Weight (Mw)

The weight-average molecular weight (Mw) of the polymer in each of the polymer solutions 1 to 3 is a value measured by a GPC method in terms of polystyrene under the following conditions.

### (GPC Measurement Conditions)

Apparatus: “HLC-8320GPC” (available from Tosoh Corporation)
Column: “TSKgel guardcolumn SuperMP(HZ)-M+TSKgel SuperMultiporeHZ-M+TSKgel SuperMultiporeHZ-M” (all available from Tosoh Corporation)
Eluent: Tetrahydrofuran (THF)
Flow rate: 0.35 mL/min
Detector: Differential refractive index (RI) detector Temperature of constant-temperature column oven: 40° C.
Calibration curve: Standard polystyrene
Sample preparation method: The polymer solution was diluted by the addition of THF and filtered through a membrane filter to provide a filtrate, which was used as a GPC measurement sample.

### Preparation of Antifouling Coating Composition

### Example 1

An antifouling coating composition was prepared as described below.

First, 14.5 parts of deionized water and 1.0 part of DISPERBYK-194N (wetting and dispersing additive, available from BYK Japan K.K.) were placed in a polyethylene container and uniformly mixed using a paint shaker. Thereafter, 14.0 parts of Talc FC-1 (extender pigment, available from Fukuoka Talc Co., Ltd.), 34.0 parts of cuprous oxide NC-301 (inorganic antifouling agent, available from NC Tech Co., Ltd.), 1.5 parts of Copper Omadine Powder (organic antifouling agent, available from Lonza K.K.), 1.0 part of TODA COLOR NM-50 (coloring pigment, available from Toda Pigment Co., Ltd.), 0.3 parts of BYK-018 (defoamer, available from BYK Japan K.K.), and 150 parts of glass beads were further added to the polyethylene container and stirred for 1 hour using the paint shaker to disperse these components, thereby preparing a mixture.

The glass beads were removed from the mixture with a filtration net (opening: 80 mesh). Then 20.4 parts of the polymer solution emulsion 1 in Production example 1, 4.0 parts of the emulsion 1 of the rosin zinc salt in Production example 4, 0.3 parts of ADEKANOL UH-752 (thickener, available from Adeka Corporation), 0.3 parts of Butyl Cellosolve (film forming aid, available from KH Neochem Co., Ltd.), 1.2 parts of Kyowanol M (film forming aid, available from KH Neochem Co., Ltd.), and 7.5 parts of Kuraray Poval 3-98 ((10% by weight aqueous solution) (poly(vinyl alcohol), available from Kuraray Co., Ltd.) were added to the resulting filtrate and dispersed for 10 minutes using a disperser to prepare an antifouling coating composition.

### Examples 2 to 21 and Comparative Examples 1 to 3

Antifouling coating compositions were prepared in the same manner as in Example 1, except that the types and amounts of components were changed as given in Tables 2-1 and 2-2.

### Evaluation of Physical Properties of Antifouling Coating Film

Antifouling coating films were formed using the antifouling coating compositions prepared in Examples and Comparative examples. The physical properties of the antifouling coating films were evaluated as described below. Tables 2-1 and 2-2 present the results.

### Crack Resistance (Water Resistance) Test of Antifouling Coating Film

An epoxy-based anticorrosive coating material (trade name: “Bannoh 1500”, available from Chugoku Marine Paints, Ltd.) was applied to a sandblasted steel plate (150 mm×70 mm×2.3 mm) using an applicator to a dry thickness of 150 μm and dried to form a cured coating film. Subsequently, an epoxy-based binder coating material (trade name: “CMP AC-EP”, available from Chugoku Marine Paints, Ltd.) was applied onto the cured coating film to a dry thickness of 100 μm and dried at 23° C. for 24 hours, thereby forming a dry coating film.

Each of the antifouling coating compositions of Examples and Comparative examples described in Tables 2-1 and 2-2 was applied to the surface of the dry coating film of the epoxy-based binder coating material using an applicator to a dry thickness of 200 μm and dried at 23° C. for 7 days to form an antifouling coating film, thereby producing test plate 1.

The test plate 1 was immersed in artificial seawater at 50° C. The appearance of the coating film was examined every month. This was performed for 4 months. The artificial seawater was replaced with fresh artificial seawater every week. The crack resistance of the antifouling coating film was evaluated in accordance with evaluation criteria described below.

Evaluation Criteria
5: There is no abnormality.
4: Cracks are observed in less than 10% of the total surface area of the coating film.
3: Cracks are observed in 10% or more and less than 20% of the total surface area of the coating film.
2: Cracks are observed in 20% or more and less than 40% of the total surface area of the coating film.
1: Cracks are observed in 40% or more of the total surface area of the coating film.

### Static Antifouling Property Test

Test plate 2 was produced in the same manner as the test plate 1 described above, except that a sandblasted steel plate (300 mm×100 mm×2.3 mm) was used. The test plate 2 was suspended and immersed in the Seto Inland Sea off the coast of Hatsukaichi City, Hiroshima Prefecture, at a depth of 0.4 m or less below the surface of the water, so as to be in a stationary state. Every month from the start of the immersion, the area (%) of a portion on the antifouling coating film to which aquatic organisms were adhered (hereinafter also referred to as “adhesion area”) was investigated, based on 100% of the total area of the antifouling coating film on the portion of the test plate 2 always immersed in seawater, and this test was performed for 4 months. The static antifouling properties were evaluated according to the following evaluation criteria.

### Evaluation Criteria

5: The adhesion area is less than 5%.
4: The adhesion area is 5% or more and less than 20%.
3: The adhesion area is 20% or more and less than 40%.
2: The adhesion area is 40% or more and less than 60%.
1: The adhesion area is 60% or more.

### Dynamic Antifouling Property Test

Test plate 3 was produced in the same manner as the test plate 1 described above, except that a sandblasted steel plate (150 mm×70 mm×1.6 mm) was used. The test plate 3 was attached to a cylinder and immersed at a position about 0.5 m below the water surface off the coast of Kure City, Hiroshima Prefecture, the cylinder rotating in such a manner that the speed of the surface (antifouling coating film) of the test plate was about 12 knots. The adhesion area (%) of aquatic organisms on the antifouling coating film was investigated every month after the start of immersion under these conditions, and this test was performed for 4 months. The dynamic antifouling properties were evaluated according to the same evaluation criteria as in the static antifouling property test.

Tables 3 and 4 present details of components used in Examples and Comparative examples.

TABLE 2-1

| | | Exam- | Exam- | Exam- | Exam- | Exam- | Exam- | Exam- |
|---|---|---|---|---|---|---|---|---|
| | | ple 1 | ple 2 | ple 3 | ple 4 | ple 5 | ple 6 | ple 7 |
| NC-301 | Inorganic | 34.0 | 34.0 | 34.0 | 34.3 | 34.0 | 34.0 | 34.0 |
| | antifouling agent | | | | | | | |
| Copper Omadine Powder | Organic | 1.5 | 1.5 | 1.5 | 1.5 | 1.5 | 1.5 | 1.5 |
| | antifouling agent | | | | | | | |
| Selektope | Organic | | | | | | | |
| | antifouling agent | | | | | | | |
| Talc FC-1 | Extender pigment | 14.0 | 14.0 | 14.0 | 14.0 | 14.0 | 14.0 | 14.0 |
| TODA COLOR NM-50 | Coloring pigment | 1.0 | 1.0 | 1.0 | 1.0 | 1.0 | 1.0 | 1.0 |
| DISPERBYK-194N | Wetting and | 1.0 | 1.0 | 1.0 | 1.0 | 1.0 | 1.0 | 1.0 |
| | dispersing additive | | | | | | | |
| BYK-018 | Defoamer | 0.3 | 0.3 | 0.3 | | 0.3 | 0.3 | 0.3 |
| Deionized water | Solvent | 14.5 | 14.5 | 14.5 | 14.5 | 14.5 | 14.5 | 14.5 |
| (Subtotal) | | 66.3 | 66.3 | 66.3 | 66.3 | 66.3 | 66.3 | 66.3 |
| Polymer solution emulsion 1 | Silyl ester copolymer | 20.4 | 18.3 | 20.4 | 20.4 | | | 21.3 |
| Polymer solution emulsion 2 | Silyl ester copolymer | | | | | 20.4 | | |
| Polymer solution emulsion 3 | Silyl ester copolymer | | | | | | 20.4 | |
| Emulsion polymerization | Silyl ester copolymer | | | | | | | |
| emulsion 4 | | | | | | | | |
| Emulsion 1 of rosin zinc salt | Rosin compound | 4.0 | 6.1 | 4.0 | 4.0 | 4.0 | 4.0 | 3.1 |
| Kuraray Poval 3-98 | Poly(vinyl alcohol) | 7.5 | | | | | | |
| (10 wt % aqueous solution) | | | | | | | | |
| Kuraray Poval 5-98 | Poly(vinyl alcohol) | | 7.5 | 7.5 | 7.5 | 7.5 | 7.5 | 7.5 |
| (10 wt % aqueous solution) | | | | | | | | |
| Kuraray Poval 5-98 | Poly(vinyl alcohol) | | | | | | | |
| (20 wt % aqueous solution) | | | | | | | | |
| Kuraray Poval 11-98 | Poly(vinyl alcohol) | | | | | | | |
| (10 wt % aqueous solution) | | | | | | | | |
| Kuraray Poval 28-98 | Poly(vinyl alcohol) | | | | | | | |
| (10 wt % aqueous solution) | | | | | | | | |
| Kuraray Poval 60-98 | Poly(vinyl alcohol) | | | | | | | |
| (10 wt % aqueous solution) | | | | | | | | |
| Kuraray Poval 5-88 | Poly(vinyl alcohol) | | | | | | | |
| (10 wt % aqueous solution) | | | | | | | | |
| Kuraray Poval 44-88 | Poly(vinyl alcohol) | | | | | | | |
| (10 wt % aqueous solution) | | | | | | | | |
| Kuraray Poval 25-88KL | Acid-modified | | | | | | | |
| (10 wt % aqueous solution) | poly(vinyl alcohol) | | | | | | | |
| Deionized water | Water | | | | | | | |
| ADEKANOL UH-752 | Thickener | 0.3 | 0.3 | 0.3 | 0.3 | 0.3 | 0.3 | 0.3 |
| Butyl Cellosolve | Film forming aid | 0.3 | 0.3 | 0.3 | 0.3 | 0.3 | 0.3 | 0.3 |
| Kyowanol M | Film forming aid | 1.2 | 1.2 | 1.2 | 1.2 | 1.2 | 1.2 | 1.2 |
| (Subtotal) | | 33.7 | 33.7 | 33.7 | 33.7 | 33.7 | 33.7 | 33.7 |
| Total | | 100.0 | 100.0 | 100.0 | 100.0 | 100.0 | 100.0 | 100.0 |
| Content ratio: silyl ester copolymer/rosin compound | | 5.2 | 3.1 | 5.2 | 5.2 | 5.2 | 5.2 | 7.2 |
| Immersion in seawater at 50° C. | 1 month | 5 | 5 | 5 | 5 | 5 | 5 | 5 |
| Crack | 2 months | 5 | 5 | 5 | 5 | 5 | 5 | 5 |
| | 3 months | 4 | 4 | 5 | 5 | 4 | 4 | 5 |
| | 4 months | 4 | 3 | 4 | 4 | 4 | 4 | 4 |
| Static antifouling properties | 1 month | 5 | 5 | 5 | 5 | 5 | 5 | 5 |
| | 2 months | 5 | 5 | 5 | 5 | 5 | 5 | 5 |
| | 3 months | 5 | 5 | 5 | 5 | 5 | 5 | 4 |
| | 4 months | 5 | 4 | 5 | 5 | 5 | 5 | 4 |
| Dynamic antifouling properties | 1 month | 5 | 5 | 5 | 5 | 5 | 5 | 5 |
| | 2 months | 5 | 5 | 5 | 5 | 5 | 5 | 5 |
| | 3 months | 5 | 5 | 5 | 4 | 5 | 5 | 5 |
| | 4 months | 5 | 5 | 5 | 4 | 4 | 4 | 5 |
| | | Exam- | Exam- | Exam- | Exam- | Exam- | Exam- | Exam- |
| | | ple 8 | ple 9 | ple 10 | ple 11 | ple 12 | ple 13 | ple 14 |
| NC-301 | Inorganic | 34.0 | 34.0 | 34.0 | 34.0 | 34.0 | 34.0 | 34.0 |
| | antifouling agent | | | | | | | |
| Copper Omadine Powder | Organic | 1.5 | 1.5 | 1.5 | 1.5 | 1.5 | 1.5 | 1.5 |
| | antifouling agent | | | | | | | |
| Selektope | Organic | 0.1 | | | | | | |
| | antifouling agent | | | | | | | |
| Talc FC-1 | Extender pigment | 14.0 | 14.0 | 14.0 | 14.0 | 14.0 | 14.0 | 14.0 |
| TODA COLOR NM-50 | Coloring pigment | 1.0 | 1.0 | 1.0 | 1.0 | 1.0 | 1.0 | 1.0 |
| DISPERBYK-194N | Wetting and | 1.0 | 1.0 | 1.0 | 1.0 | 1.0 | 1.0 | 1.0 |
| | dispersing additive | | | | | | | |
| BYK-018 | Defoamer | 0.3 | 0.3 | 0.3 | 0.3 | 0.3 | 0.3 | 0.3 |
| Deionized water | Solvent | 14.4 | 14.5 | 14.5 | 17.3 | 14.5 | 14.5 | 14.5 |
| (Subtotal) | | 66.3 | 66.3 | 66.3 | 69.1 | 66.3 | 66.3 | 66.3 |
| Polymer solution emulsion 1 | Silyl ester copolymer | 21.3 | 22.2 | 22.7 | 20.4 | 20.4 | 20.4 | 20.4 |
| Polymer solution emulsion 2 | Silyl ester copolymer | | | | | | | |
| Polymer solution emulsion 3 | Silyl ester copolymer | | | | | | | |
| Emulsion polymerization | Silyl ester copolymer | | | | | | | |
| emulsion 4 | | | | | | | | |
| Emulsion 1 of rosin zinc salt | Rosin compound | 3.1 | 2.2 | 1.7 | 4.0 | 4.0 | 4.0 | 4.0 |
| Kuraray Poval 3-98 | Poly(vinyl alcohol) | | | | | | | |
| (10 wt % aqueous solution) | | | | | | | | |
| Kuraray Poval 5-98 | Poly(vinyl alcohol) | 7.5 | 7.5 | 7.5 | | 5.6 | 3.8 | 1.9 |
| (10 wt % aqueous solution) | | | | | | | | |
| Kuraray Poval 5-98 | Poly(vinyl alcohol) | | | | 4.7 | | | |
| (20 wt % aqueous solution) | | | | | | | | |
| Kuraray Poval 11-98 | Poly(vinyl alcohol) | | | | | | | |
| (10 wt % aqueous solution) | | | | | | | | |
| Kuraray Poval 28-98 | Poly(vinyl alcohol) | | | | | | | |
| (10 wt % aqueous solution) | | | | | | | | |
| Kuraray Poval 60-98 | Poly(vinyl alcohol) | | | | | | | |
| (10 wt % aqueous solution) | | | | | | | | |
| Kuraray Poval 5-88 | Poly(vinyl alcohol) | | | | | | | |
| (10 wt % aqueous solution) | | | | | | | | |
| Kuraray Poval 44-88 | Poly(vinyl alcohol) | | | | | | | |
| (10 wt % aqueous solution) | | | | | | | | |
| Kuraray Poval 25-88KL | Acid-modified | | | | | | | |
| (10 wt % aqueous solution) | poly(vinyl alcohol) | | | | | | | |
| Deionized water | Water | | | | | 1.9 | 3.8 | 5.6 |
| ADEKANOL UH-752 | Thickener | 0.3 | 0.3 | 0.3 | 0.3 | 0.3 | 0.3 | 0.3 |
| Butyl Cellosolve | Film forming aid | 0.3 | 0.3 | 0.3 | 0.3 | 0.3 | 0.3 | 0.3 |
| Kyowanol M | Film forming aid | 1.2 | 1.2 | 1.2 | 1.2 | 1.2 | 1.2 | 1.2 |
| (Subtotal) | | 33.7 | 33.7 | 33.7 | 30.9 | 33.7 | 33.7 | 33.7 |
| Total | | 100.0 | 100.0 | 100.0 | 100.0 | 100.0 | 100.0 | 100.0 |
| Content ratio: silyl ester copolymer/rosin compound | | 7.2 | 10.3 | 13.7 | 5.2 | 5.2 | 5.2 | 5.2 |
| Immersion in seawater at 50° C. | 1 month | 5 | 5 | 5 | 5 | 5 | 5 | 5 |
| Crack | 2 months | 5 | 5 | 5 | 5 | 5 | 5 | 5 |
| | 3 months | 4 | 5 | 5 | 5 | 5 | 5 | 4 |
| | 4 months | 3 | 4 | 4 | 4 | 4 | 4 | 4 |
| Static antifouling properties | 1 month | 5 | 5 | 5 | 5 | 5 | 5 | 5 |
| | 2 months | 5 | 5 | 5 | 5 | 5 | 5 | 5 |
| | 3 months | 5 | 4 | 4 | 4 | 5 | 5 | 5 |
| | 4 months | 5 | 3 | 3 | 3 | 4 | 4 | 4 |
| Dynamic antifouling properties | 1 month | 5 | 5 | 5 | 5 | 5 | 5 | 5 |
| | 2 months | 5 | 5 | 5 | 5 | 5 | 5 | 5 |
| | 3 months | 5 | 5 | 4 | 5 | 5 | 5 | 5 |
| | 4 months | 5 | 4 | 3 | 5 | 5 | 5 | 5 |

TABLE 2-2

| | | Exam- | Exam- | Exam- | Exam- | Exam- | Exam- |
|---|---|---|---|---|---|---|---|
| | | ple 15 | ple 16 | ple 17 | ple 18 | ple 19 | ple 20 |
| NC-301 | Inorganic | 34.0 | 34.0 | 34.0 | 34.0 | 34.0 | 34.0 |
| | antifouling agent | | | | | | |
| Copper Omadine Powder | Organic | 1.5 | 1.5 | 1.5 | 1.5 | 1.5 | 1.5 |
| | antifouling agent | | | | | | |
| Selektope | Organic | | | | | | |
| | antifouling agent | | | | | | |
| Talc FC-1 | Extender pigment | 14.0 | 14.0 | 14.0 | 14.0 | 14.0 | 14.0 |
| TODA COLOR NM-50 | Coloring pigment | 1.0 | 1.0 | 1.0 | 1.0 | 1.0 | 1.0 |
| DISPERBYK-194N | Wetting and | 1.0 | 1.0 | 1.0 | 1.0 | 1.0 | 1.0 |
| | dispersing additive | | | | | | |
| BYK-018 | Defoamer | 0.3 | 0.3 | 0.3 | 0.3 | 0.3 | 0.3 |
| Deionized water | Solvent | 14.5 | 14.5 | 14.5 | 14.5 | 14.5 | 14.5 |
| (Subtotal) | | 66.3 | 66.3 | 66.3 | 66.3 | 66.3 | 66.3 |
| Polymer solution emulsion 1 | Silyl ester copolymer | 20.4 | 20.4 | 20.4 | 20.4 | 20.4 | 20.4 |
| Polymer solution emulsion 2 | Silyl ester copolymer | | | | | | |
| Polymer solution emulsion 3 | Silyl ester copolymer | | | | | | |
| Emulsion | Silyl ester copolymer | | | | | | |
| polymerization emulsion 4 | | | | | | | |
| Emulsion 1 of rosin zinc salt | Rosin compound | 4.0 | 4.0 | 4.0 | 4.0 | 4.0 | 4.0 |
| Kuraray Poval 3-98 | Poly(vinyl alcohol) | | | | | | |
| (10 wt % aqueous solution) | | | | | | | |
| Kuraray Poval 5-98 | Poly(vinyl alcohol) | | | | | | |
| (10 wt % aqueous solution) | | | | | | | |
| Kuraray Poval 5-98 | Poly(vinyl alcohol) | | | | | | |
| (20 wt % aqueous solution) | | | | | | | |
| Kuraray Poval 11-98 | Poly(vinyl alcohol) | 7.5 | | | | | |
| (10 wt % aqueous solution) | | | | | | | |
| Kuraray Poval 28-98 | Poly(vinyl alcohol) | | 7.5 | | | | |
| (10 wt % aqueous solution) | | | | | | | |
| Kuraray Poval 60-98 | Poly(vinyl alcohol) | | | 7.5 | | | |
| (10 wt % aqueous solution) | | | | | | | |
| Kuraray Poval 5-88 | Poly(vinyl alcohol) | | | | 7.5 | | |
| (10 wt % aqueous solution) | | | | | | | |
| Kuraray Poval 44-88 | Poly(vinyl alcohol) | | | | | 7.5 | |
| (10 wt % aqueous solution) | | | | | | | |
| Kuraray Poval 25-88KL | Acid-modified | | | | | | 7.5 |
| (10 wt % aqueous solution) | poly(vinyl alcohol) | | | | | | |
| Deionized water | Water | | | | | | |
| ADEKANOL UH-752 | Thickener | 0.3 | 0.3 | 0.3 | 0.3 | 0.3 | 0.3 |
| Butyl Cellosolve | Film forming aid | 0.3 | 0.3 | 0.3 | 0.3 | 0.3 | 0.3 |
| Kyowanol M | Film forming aid | 1.2 | 1.2 | 1.2 | 1.2 | 1.2 | 1.2 |
| (Subtotal) | | 33.7 | 33.7 | 33.7 | 33.7 | 33.7 | 33.7 |
| Total | | 100.0 | 100.0 | 100.0 | 100.0 | 100.0 | 100.0 |
| Content ratio: silyl ester copolymer/rosin compound | | 5.2 | 5.2 | 5.2 | 5.2 | 5.2 | 5.2 |
| Immersion in seawater at 50° C. | 1 month | 5 | 5 | 5 | 5 | 5 | 5 |
| Crack | 2 months | 5 | 5 | 5 | 4 | 4 | 5 |
| | 3 months | 5 | 4 | 4 | 3 | 4 | 3 |
| | 4 months | 4 | 3 | 3 | 3 | 3 | 3 |
| Static antifouling properties | 1 month | 5 | 5 | 5 | 5 | 5 | 5 |
| | 2 months | 5 | 5 | 5 | 5 | 5 | 5 |
| | 3 months | 5 | 5 | 5 | 4 | 4 | 4 |
| | 4 months | 5 | 4 | 4 | 3 | 3 | 3 |
| Dynamic antifouling properties | 1 month | 5 | 5 | 5 | 5 | 5 | 5 |
| | 2 months | 5 | 5 | 5 | 5 | 5 | 4 |
| | 3 months | 5 | 5 | 5 | 4 | 4 | 3 |
| | 4 months | 5 | 4 | 4 | 3 | 3 | 3 |

| | | | Compar- | Compar- | Compar- |
|---|---|---|---|---|---|
| | | | ative | ative | ative |
| | | Exam- | exam- | exam- | exam- |
| | | ple 21 | ple 1 | ple 2 | ple 3 |
| NC-301 | Inorganic | 34.0 | 34.0 | 34.0 | 34.0 |
| | antifouling agent | | | | |
| Copper Omadine Powder | Organic | 1.5 | 1.5 | 1.5 | 1.5 |
| | antifouling agent | | | | |
| Selektope | Organic | | | | |
| | antifouling agent | | | | |
| Talc FC-1 | Extender pigment | 14.0 | 14.0 | 14.0 | 14.0 |
| TODA COLOR NM-50 | Coloring pigment | 1.0 | 1.0 | 1.0 | 1.0 |
| DISPERBYK-194N | Wetting and | 1.0 | 1.0 | 1.0 | 1.0 |
| | dispersing additive | | | | |
| BYK-018 | Defoamer | 0.3 | 0.3 | 0.3 | 0.3 |
| Deionized water | Solvent | 14.5 | 22.0 | 14.5 | 14.5 |
| (Subtotal) | | 66.3 | 73.8 | 66.3 | 66.3 |
| Polymer solution emulsion 1 | Silyl ester copolymer | | 20.4 | 24.4 | |
| Polymer solution emulsion 2 | Silyl ester copolymer | | | | |
| Polymer solution emulsion 3 | Silyl ester copolymer | | | | |
| Emulsion | Silyl ester copolymer | 20.4 | | | 20.4 |
| polymerization emulsion 4 | | | | | |
| Emulsion 1 of rosin zinc salt | Rosin compound | 4.0 | 4.0 | | 4.0 |
| Kuraray Poval 3-98 | Poly(vinyl alcohol) | | | | |
| (10 wt % aqueous solution) | | | | | |
| Kuraray Poval 5-98 | Poly(vinyl alcohol) | 7.5 | | 7.5 | |
| (10 wt % aqueous solution) | | | | | |
| Kuraray Poval 5-98 | Poly(vinyl alcohol) | | | | |
| (20 wt % aqueous solution) | | | | | |
| Kuraray Poval 11-98 | Poly(vinyl alcohol) | | | | |
| (10 wt % aqueous solution) | | | | | |
| Kuraray Poval 28-98 | Poly(vinyl alcohol) | | | | |
| (10 wt % aqueous solution) | | | | | |
| Kuraray Poval 60-98 | Poly(vinyl alcohol) | | | | |
| (10 wt % aqueous solution) | | | | | |
| Kuraray Poval 5-88 | Poly(vinyl alcohol) | | | | |
| (10 wt % aqueous solution) | | | | | |
| Kuraray Poval 44-88 | Poly(vinyl alcohol) | | | | |
| (10 wt % aqueous solution) | | | | | |
| Kuraray Poval 25-88KL | Acid-modified | | | | |
| (10 wt % aqueous solution) | poly(vinyl alcohol) | | | | |
| Deionized water | Water | | | | 5.7 |
| ADEKANOL UH-752 | Thickener | 0.3 | 0.3 | 0.3 | 0.3 |
| Butyl Cellosolve | Film forming aid | 0.3 | 0.3 | 0.3 | 0.3 |
| Kyowanol M | Film forming aid | 3.0 | 1.2 | 1.2 | 3.0 |
| (Subtotal) | | 35.5 | 26.2 | 33.7 | 33.7 |
| Total | | 101.8 | 100.0 | 100.0 | 100.0 |
| Content ratio: silyl ester copolymer/rosin compound | | 5.6 | 5.2 | — | 5.6 |
| Immersion in seawater at 50° C. | 1 month | 5 | 4 | 5 | 4 |
| Crack | 2 months | 5 | 3 | 5 | 3 |
| | 3 months | 5 | 1 | 4 | 1 |
| | 4 months | 4 | 1 | 3 | 1 |
| Static antifouling properties | 1 month | 5 | 5 | 4 | 5 |
| | 2 months | 5 | 4 | 3 | 4 |
| | 3 months | 4 | 3 | 2 | 3 |
| | 4 months | 3 | 2 | 1 | 2 |
| Dynamic antifouling properties | 1 month | 5 | 5 | 3 | 5 |
| | 2 months | 5 | 4 | 2 | 4 |
| | 3 months | 4 | 3 | 1 | 3 |
| | 4 months | 3 | 3 | 1 | 3 |

TABLE 3

| | | | | Solid content |
|---|---|---|---|---|
| | | | | concentration |
| Component | | Product name | Manufacturer | (% by mass) |
| Silyl ester | Emulsion of silyl ester copolymer | (Polymer solution emulsion 1~3) | — | 45 |
| copolymer | | (Emulsion polymerization emulsion 4) | — | 45 |
| Rosin | Emulsion of rosin zinc salt | (Emulsion 1 of rosin zinc salt) | — | 45 |
| compound | | | | |
| Poly(vinyl | Poly(vinyl alcohol), degree of | Kuraray Poval 3-98 (10 wt % aqueous | Kuraray Co., Ltd. | 10 |
| alcohol) | saponification: 98 mol % | solution) | | |
| | Poly(vinyl alcohol), degree of | Kuraray Poval 5-98 (10 wt % aqueous | Kuraray Co., Ltd. | 10 |
| | saponification: 98 mol % | solution) | | |
| | Poly(vinyl alcohol), degree of | Kuraray Poval 5-98 (20 wt % aqueous | Kuraray Co., Ltd. | 20 |
| | saponification: 98 mol % | solution) | | |
| | Poly(vinyl alcohol), degree of | Kuraray Poval 11-98 (10 wt % aqueous | Kuraray Co., Ltd. | 10 |
| | saponification: 98 mol % | solution) | | |
| | Poly(vinyl alcohol), degree of | Kuraray Poval 28-98 (10 wt % aqueous | Kuraray Co., Ltd. | 10 |
| | saponification: 98 mol % | solution) | | |
| | Poly(vinyl alcohol), degree of | Kuraray Poval 60-98 (10 wt % aqueous | Kuraray Co., Ltd. | 10 |
| | saponification: 98 mol % | solution) | | |
| | Poly(vinyl alcohol), degree of | Kuraray Poval 5-88 (10 wt % aqueous | Kuraray Co., Ltd. | 10 |
| | saponification: 88 mol % | solution) | | |
| | Poly(vinyl alcohol), degree of | Kuraray Poval 44-88 (10 wt % aqueous | Kuraray Co., Ltd. | 10 |
| | saponification: 88 mol % | solution) | | |
| | Acid-modified poly(vinyl alcohol), | Kuraray Poval 25-88KL (10 wt % | Kuraray Co., Ltd. | 10 |
| | degree of saponification: 88 mol % | aqueous solution) | | |
| Water | Deionized water | — | — | — |

TABLE 4

| | | | | Solid content |
|---|---|---|---|---|
| | | | | concentration |
| Component | | Product name | Manufacturer | (% by mass) |
| Inorganic antifouling | Cuprous oxide (D50 = 2.9 μm) | NC-301 | NC Tech Co., Ltd. | 100 |
| agent | | | | |
| Organic antifouling | Copper pyrithione | Copper Omadine | Lonza K.K. | 100 |
| | | Powder | | |
| agent | Medetomidine | Selektope | I-Tech AB | 100 |
| Extender pigment | Talc | Talc FC-1 | Fukuoka Talc Co., Ltd. | 100 |
| Coloring pigment | Red iron oxide | TODA COLOR NM-50 | Toda Pigment Co., Ltd. | 100 |
| Wetting and dispersing | Solution of copolymer having | DISPERBYK-194N | BYK Japan K.K. | 57 |
| additive | group with affinity for pigment | | | |
| Defoamer | Mixture of foam-destroying | BYK-018 | BYK Japan K.K. | 100 |
| | polysiloxane and hydrophobic | | | |
| | particles | | | |
| Thickener | Polyether polyol urethane | ADEKANOL UH-752 | ADEKA Corp. | 28 |
| | polymer | | | |
| Film forming aid | Ethylene glycol monobutyl | Butyl Cellosolve | KH Neochem Co., Ltd. | 0 |
| | ether | | | |
| | 2,2,4-Trimethyl-1,3-pentanediol | Kyowanol M | KH Neochem Co., Ltd. | 0 |
| | monoisobutyrate | | | |

What is claimed is:

1. An antifouling coating composition, comprising:
a silyl ester polymer;
at least one rosin compound selected from rosin and rosin derivatives;
a poly(vinyl alcohol) resin; and
water.

2. The antifouling coating composition according to claim 1, wherein the silyl ester polymer comprises a structural unit derived from triisopropylsilyl methacrylate.

3. The antifouling coating composition according to claim 1, wherein the rosin compound is a rosin metal salt.

4. The antifouling coating composition according to claim 3, wherein the rosin metal salt is a rosin zinc salt.

5. The antifouling coating composition according to claim 1, wherein a mass ratio of the silyl ester polymer to the rosin compound, which is a silyl ester polymer content/a rosin compound content, is from 2.8 to 15.

6. The antifouling coating composition according to claim 1, wherein the poly(vinyl alcohol) resin has a degree of saponification of 85% or more by mole.

7. The antifouling coating composition according to claim 1, wherein a proportion of the poly(vinyl alcohol) resin contained is from 0.25% to 1.5% by mass based on 100% by mass of a solid content of the antifouling coating composition.

8. The antifouling coating composition according to claim 1, further comprising:
an antifouling agent.

9. An antifouling coating film formed from the antifouling coating composition according to claim 1.

10. An antifouling substrate, comprising:
a substrate; and
the antifouling coating film according to claim 9, the antifouling coating film being disposed on a surface of the substrate.

11. A method for producing an antifouling substrate, comprising:
subjecting a substrate to application of or impregnation with the antifouling coating composition according to claim 1 to provide an applied body or an impregnated body; and
drying the applied body or the impregnated body.
